(19) United States
(12) Patent Application Publication
(10) Pub. No.: US 2015/0311000 A1
(43) Pub. Date: Oct. 29, 2015

(54) DYE-SENSITIZED SOLAR CELL PACKAGE AND METHOD FOR MANUFACTURING THE SAME

(71) Applicant: HON HAI PRECISION INDUSTRY CO., LTD., New Taipei (TW)

(72) Inventor: HSIN-HUA CHANG, New Taipei (TW)

(21) Appl. No.: 14/568,744

(22) Filed: Dec. 12, 2014

(30) Foreign Application Priority Data
Apr. 28, 2014 (TW) 103115229

(51) Int. Cl. H01G 9/20; H01G 9/00

(52) U.S. Cl. CPC H01G 9/2077; H01G 9/0036; H01G 9/2031

(57) ABSTRACT

A dye-sensitized solar cell package including a lower substrate, a glass layer, an upper cover arranged series. The glass layer is between the upper cover and the lower substrate. Two conductive metal layers are respectively formed on the surface of the upper cover and the lower substrate which are oriented toward the glass layer. The upper cover, the glass layer and the lower substrate are welded together by laser. The invention also provides a method for manufacturing the dye sensitized solar cells package.

### CROSS-REFERENCE TO RELATED APPLICATIONS

This application claims priority to Chinese Patent Application No. 103115229 filed on Apr. 28, 2014 in the State Intellectual Property Office Of The P. R. C, the contents of which are incorporated by reference herein.

### FIELD

The disclosure relates to a solar cell, and specially relates to a dye-sensitized solar cell package and method for manufacturing the same.

### BACKGROUND

A dye-sensitized solar cell includes an upper glass plate, a lower glass plate and UV glue sandwiched between the upper glass plate and the lower glass plate. When the dye-sensitized solar cell is manufactured, titania, pigment and electrolyte are filled in a space between the upper glass plate and the lower glass plate to package UV glue.

### BRIEF DESCRIPTION OF THE DRAWINGS

Implementations of the present technology will now be described, by way of example only, with reference to the attached figures.

FIG. 1 is an assembled view of a dye-sensitized solar cell package in accordance with an exemplary embodiment of the present disclosure.

FIG. 2 is a cross sectional view of the dye-sensitized solar cell package of FIG. 1, taken along II-II line thereof.

FIG. 3 is an exploded view of the dye-sensitized solar cell package of FIG. 1.

FIG. 4 is an assemble view of the glass plate of a dye-sensitized solar cell package.

FIG. 5 is a isometric view showing the welding method of a dye-sensitized solar cell.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like.

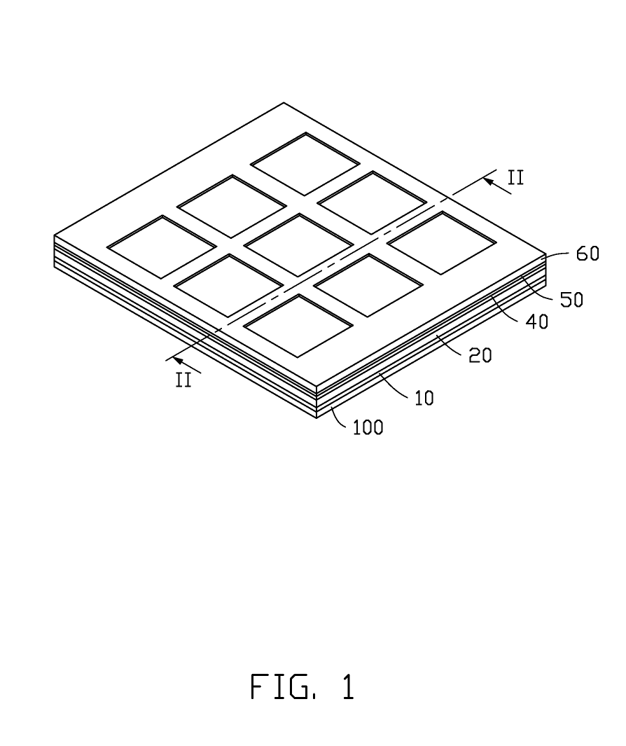

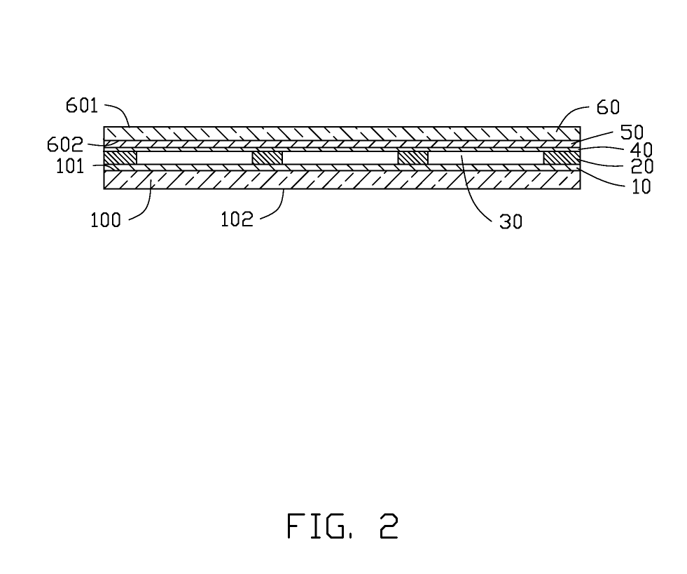

Referring to FIGS. 1 and 2, a dye-sensitized solar cell package including a lower substrate 100, a conductive metal layer 10, a glass layer 20, a chemical material layer 30, a catalytic layer 40, a conductive metal layer 50, and an upper cover 60 arranged series.

The lower substrate 100 is rectangular and made of white glass or resin material. The lower substrate 100 includes an upper surface 101 and a lower surface 102 opposite to the upper surface 101. The conductive metal layer 10 is formed on the upper surface 101. A thickness of the conductive metal layer 10 is less than that of the lower substrate 100.

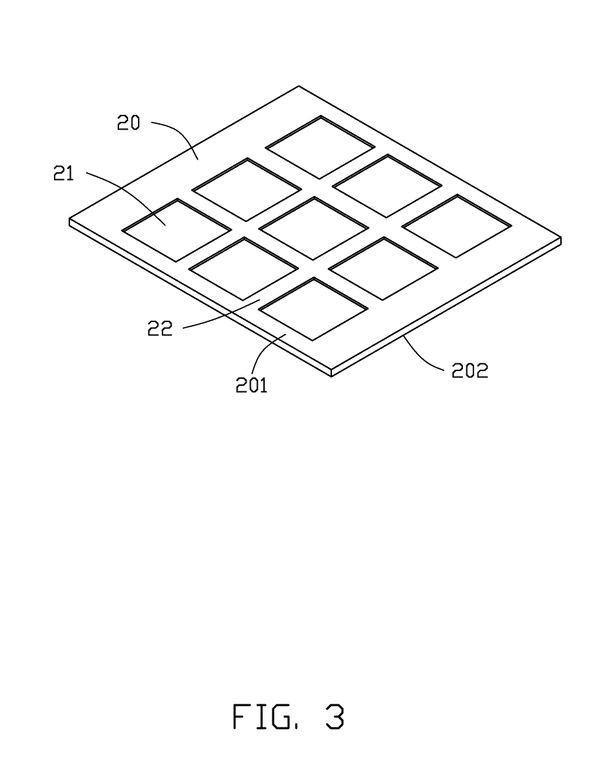

Referring also to FIG. 3, the glass layer 20 includes an upper surface 201 and a lower surface 202 oppsite to the upper surface 201. A plurality of filling spaces 21 is defined in the glass layer 20 and extend through the upper surface 201 and the lower surface 202. A plurality of the blocking parts 22 are formed between filling spaces 21 to separate the adjacent filling spaces 21. A thickness of the glass layer 20 is varied between 0.1 mm-0.2 mm or is less than 0.1 mm. The glass layer 20 is made of silicate, has high resistance to corrosion and can be cut and bended. A size of the glass layer 20 is same that of the lower substrate 100. The glass layer 20 is formed on the conductive metal layer 10.

The chemical material layer 30 is filled in the filling spaces 21. The chemical material layer 30 is made of titania, dye and electrolyte. The chemical material layer 30 is manufactured includes following steps: firstly, coating the titania to the conductive metal layer 10 and hoting the titania form a film, then filling the dye and electrolyte to the film to form the chemical material layer 30. It can be understood that the chemical material layer 30 may includes other active substance to promote its transfer efficiency thereof.

The catalytic layer 40 is made of metal material. In this embodiment, the catalytic layer 40 is made of Pt. The catalytic layer 40 is arranged on the glass layer 20 and to cover the chemical material layer 30 to improve the reaction efficiency of the chemical material layer 30.

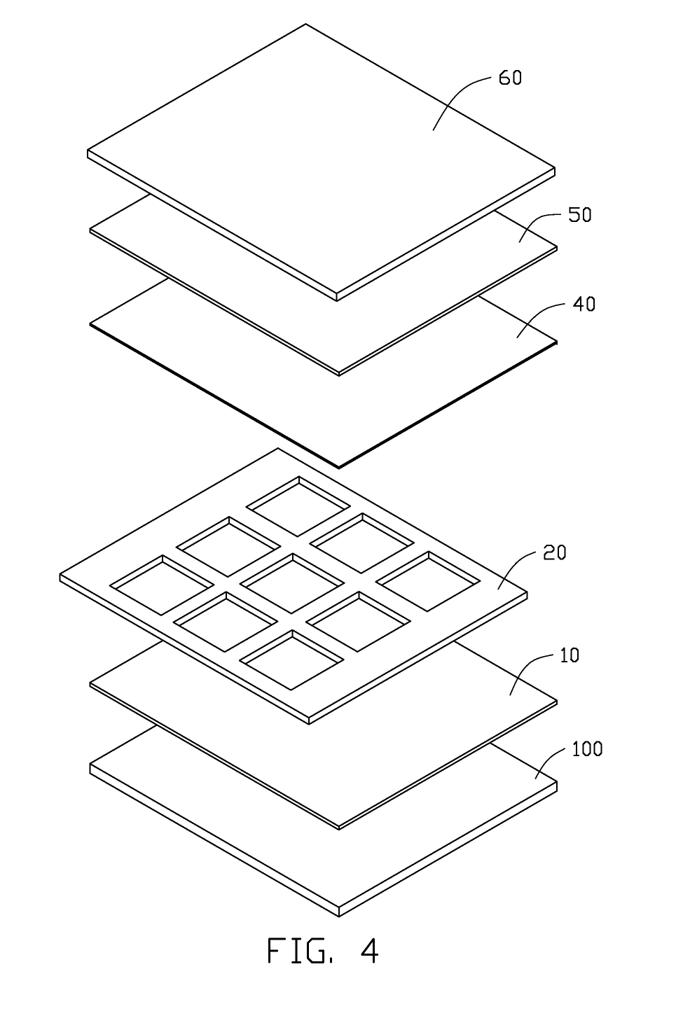

Refering to FIG. 2 and FIG. 4, a size of the upper cover 60 is the same that of the lower substrate 100. The upper cover 60 includes an upper surface 601 and a lower surface 602. The conductive metal layer 50 is formed on the lower surface 602 of the upper cover 60. A thickness of the conductive layer 50 is less than that of the upper cover 60.

A method for manufacturing the dye-sensitized solar cell package includes following steps:

Providing the lower substrate 100, forming the conductive metal 10 layer on the upper surface 101 of the lower substrate 100 by palting. The thickness of the conductive metal layer 10 is less than the thickness of the lower substrate 100 and the size of the conductive metal layer 10 is same to the size of the lower substrate 100.

Providing the glass layer 20, etching the glass layer 20 to define a plurality of the filling spaces 21 therein. The filling spaces 21 extend through the upper surface 201 and the lower surface 202. In this embodiment, the filling spaces 21 is rectangular. It can be understood that the filling spaces 21 is other shape. A plurality of the blocking parts 22 are formed between filling spaces 21 to separate the adjacent filling spaces 21.

Attaching the glass layer 20 to the conductive metal layer 10.

Welding the glass layer 20 and the lower substrate 100 together using 10⁻¹⁵ s pulsed laser.

Providing the chemical material layer 30, and filling the chemical material layer 30 into the filling spaces 21.

Providing the catalytic layer 40, coating the catalytic layer 40 to the upper surface 201 of the glass layer 20.

Providing the upper cover 60 and plating a conductive metal layer 50 to the lower surface 602 of the upper substrate 60.

Laminating the conductive metal layer 50 of the upper substrate 60 towards the catalytic layer 40, and pressing the upper cover 60 on the catalytic layer 40.

Using 10⁻¹⁵ s pulsed laser aiming the block portion 22 to weld the upper cover 60 and glass layer 20 together. In this states the dye-sensitized solar cell package is manufactured completly.

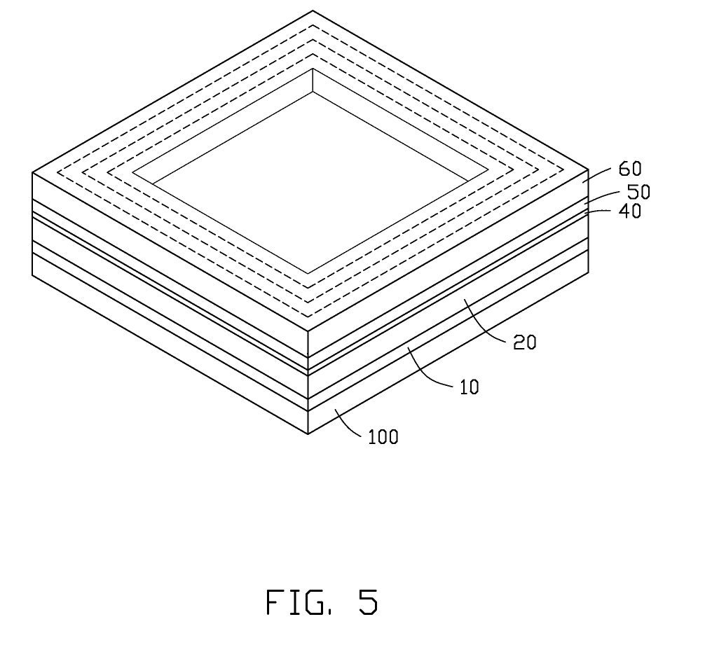

In above dye-sensitized solar cell package, the welding of the invention is using step by step. Firstly, welding the glass layer 20 and lower substrate 100 together, secondly, filling the chemical material layer 30 to the glass layer 20, lastly, welding the upper cover 60 and the glass layer 20 together. The welding needs 10⁻¹⁵ s pulsed laser in the dust-free environment. Referring to the FIG. 5, in this embodiment, the welding use 10⁻¹⁵ s pulsed laser. The 10⁻¹⁵ s pulsed laser must aim accurately to the blocking portion 22. The upper cover 60, lower substrate 100 and glass layer 20 is welded by the way of multiple dotted line. The dotted line is formed around the filling spaces 21. Because the different glass material have different reflective index, it needs adjust the parameter of the 10⁻¹⁵ s pulsed laser.

This invention is to cut a plurality of filling spaces 21 in the glass layer 20 to fill the chemical material layer 30 and weld the upper cover 60, the glass layer 20 and the lower substrate 100 by the 10⁻¹⁵ s pulsed laser. The glass layer 20 has great corrosion resistance to avoid the electrolyte to damage UV glue of the dye-sensitized solar cell package. So the dye-sensitized solar cell package of this invention have good stability and high service life.

It is to be further understood that even though numerous characteristics and advantages have been set forth in the foregoing description of embodiments, together with details of the structures and functions of the embodiments, the disclosure is illustrative only; and that changes may be made in detail, including in matters of shape, size, and arrangement of parts within the principles of the disclosure to the full extent indicated by the broad general meaning of the terms in which the appended claims are expressed.

The embodiments shown and described above are only examples. Many details are often found in the art such as the other features of an LED die and a method of manufacturing the LED die. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A dye-sensitized solar cell package comprising:
a lower substrate;
an upper cover;
a glass layer arranged between the lower substrate and the upper cover, and
a conductive metal layer formed on an upper surface of the lower substrate and a lower surface of the upper cover;
wherein the upper cover and the glass layer are layer welded, and the lower substrate and the glass layer are laser welded.

2. The dye-sensitized solar cell package of claim 1, wherein a plurality of filling spaces is defined in the glass layer and extend through the upper surface and the lower surface of the glass layer.

3. The dye-sensitized solar cell package of claim 2, wherein a plurality of the blocking parts are formed between filling spaces to separate the adjacent filling spaces.

4. The dye-sensitized solar cell package of claim 2, wherein the chemical material layer is filled in the filling spaces.

5. The dye-sensitized solar cell package of claim 4, wherein the chemical material layer includes titania, dye and electrolyte.

6. The dye-sensitized solar cell package of claim 1, wherein also including a catalytic layer formed on the upper surface of the glass layer.

7. A method for manufacturing the dye-sensitized solar cell package includes following steps:
Providing the lower substrate and forming the conductive metal layer on the upper surface of the lower substrate by palting;
providing the glass layer;
etching the glass layer to define a plurality of the filling spaces therein;
attaching the glass layer to the conductive metal layer;
welding the glass layer and the lower substrate together;
providing the chemical material layer, and filling the chemical material layer into the filling space;
providing the catalytic layer, coating the catalytic layer to the upper surface of the glass layer;
providing the upper cover and plating a conductive metal layer to the lower surface of the upper substrate;
laminating the conductive metal layer of the upper substrate towards the catalytic layer, and pressing the upper cover on the catalytic layer;
welding the upper cover and the glass layer together.

8. The method of claim 7, wherein the upper cover and the glass layer, the lower substrate and the glass layer are weld by the way of multiple dotted line.

9. The method of claim 7, wherein the welding needs 10⁻¹⁵ s pulsed laser in the dust-free environment.

10. The method of claim 7, wherein the filling spaces extend through the upper surface and the lower surface of the glass layer.

11. The method of claim 7, wherein a plurality of the blocking parts are formed between filling spaces to separate the adjacent filling spaces.

12. The method of claim 11, wherein while welding, the laser must aim to the upper cover corresponding to the blocking part and the lower substrate corresponding to the blocking part.
